(19) United States
(12) Patent Application Publication
(10) Pub. No.: US 2014/0203203 A1
(43) Pub. Date: Jul. 24, 2014

(54) SEALING SYSTEM FOR INDUSTRIAL VALVES, PARTICULARLY FOR BALL VALVES, AND VALVE COMPRISING SAID SYSTEM

(71) Applicant: Roberto Scattini, Credaro (IT)

(72) Inventor: Roberto Scattini, Credaro (IT)

(73) Assignee: GASKET INTERNATIONAL S.P.A., Cividino Di Castelli Calepio (IT)

(21) Appl. No.: 14/237,769

(22) PCT Filed: Aug. 8, 2011
(86) PCT No.: PCT/IB2011/053529

§ 371 Date: Feb. 7, 2014

(51) Int. Cl. F16K 5/06; F16K 5/20

(52) U.S. Cl. CPC F16K 5/0663; F16K 5/20
USPC 251/317

(57) ABSTRACT

The present invention relates to a sealing system particularly for industrial safety valves, more particularly for industrial ball valves. Thus, the present invention relates both to a sealing system and to a ball valve comprising said sealing system. The sealing system according to the present invention is of the type comprising an elastomeric element (500) and a thermoplastic element (600), and is characterized in that the elastomeric element (500) that provides fluid sealing is held in its seating exclusively by a thermoplastic element (600) and by the particular shape of the seating (400) of said elements within the seat (200), and is held stably in position by these.

### FIELD OF THE INVENTION

The present invention relates to a sealing system particularly for industrial safety valves, more particularly for industrial ball valves, as well as a valve comprising said sealing system.

### PRIOR ART

Safety valves, in particular ball valves, are complex systems comprising a plurality of components, which can generally be operated by means of a mechanical actuator.

In the case of ball valves, these basically comprise at least one main body, at least one seat or seating, and at least one ball.

Between the seat and the ball of the valve, at least one sealing element is provided for ensuring proper sealing of the valve and at the same time allowing relative movement between seat and ball to realizing opening and closing of said valve.

Said sealing elements known from the prior art generally consist of rubber O-rings to provide hermetic closure between the seat and the ball. The use of a rubber sealing element offers numerous advantages, making it the preferred solution compared with the use of other materials.

These advantages are mainly connected with the good capacity of rubber in providing excellent sealing even in the case of a surface finish of the ball that is not defect-free or indeed has a certain degree of surface roughness. The use of a rubber sealing element therefore allows excellent sealing to be obtained, while keeping manufacturing costs lows as it is not necessary to specify exacting requirements on tolerances, surface finish and ball form errors.

At the same time, however, the use of an O-ring seal as the sealing element has some drawbacks, primarily the risk of the valve “seizing”, i.e. in the case of high operating pressures there is deformation of the rubber O-ring and the seat comes in contact with the ball. The metal-to-metal contact between seat and ball can ultimately cause seizing of the valve or at least deformation of the ball surface, even to an irreparable extent.

Yet another drawback affecting valves is that particulates, dust and dirt in general present in the fluid can get between seat and ball, reaching the sealing element and in the long run compromising its operation even to the extent of seizing of the valve itself.

Thus, a limitation of valves comprising only a rubber gasket of the O-ring type as the sealing element is that they are unreliable for high pressures of the fluid, high pressures meaning pressure values above 100 bar.

To improve valve sealing even at higher values of pressure of the fluid, solutions are available on the market that envisage, as the sealing element, a ring that has a substantially trapezoidal cross-section, more precisely of delta shape, known as a delta-ring. Even this solution, although offering improvements in terms of sealing at high pressures, has not proved entirely satisfactory for overcoming the drawbacks mentioned above.

Besides these solutions that envisage the use of rubber sealing rings, valves are known in this sector that use elements made of thermoplastics for providing the seat-ball seal. Examples of materials used are PTFE (with various compounds), nylon, PEEK, and similar thermoplastic polymers with high hardness.

These sealing elements made of plastics have the advantage, relative to the rubber O-rings or delta-rings, of preventing metal-to-metal contact between seat and ball even at high operating pressures as they are less easily deformable compared with rubber. Conversely, a drawback connected with the use of thermoplastics for making the sealing element of an industrial valve of the type in question arises from the need to have greatly reduced tolerances on machining and/or misalignments in assembly of the valve components and a greatly reduced surface roughness of the ball, which must accordingly have a polished surface finish, in order to guarantee good sealing.

The need to provide this quality of machining and control of tolerances during component manufacture leads to a notable increase in costs of production, making the valves provided with sealing elements made of thermoplastics much more expensive, and presenting the risk that manufacturing defects may have repercussions on good sealing of the valve itself.

To overcome these drawbacks, the same applicant has designed a new sealing system, which was the object of patent application WO2011/033536.

Said sealing system for industrial valves, in particular for two-way single-action or double-action piston ball valves, comprises at least one seat suitable for insertion in the housing of a ball valve, and a sealing element made of elastomeric material able to provide fluid sealing between said seat and the ball of said valve, and is further characterized in that it comprises, on the surface of said seat that is intended to be opposite said ball, at least one further element made of thermoplastic material.

Referring in particular to FIG. 1, this shows an example of an embodiment of the sealing system that is the object of this patent application.

The sealing system 1 illustrated in application WO2001/033536 comprises a seat 20 for sealing on a ball 30 and able to interact with a valve body 10. The seat 20 interacts with the valve body 10 as is known from the prior art, therefore, for example, a helical spring 40, an O-ring seal, a “U” collar 60 and two “BK” collars 70 can advantageously be provided between said seat 20 and said valve body 10.

The operation of the safety valves under discussion is known. The pressure exerted by the fluid acting on the external part of seat 20 pushes said seat against the ball 30.

The operation of the sealing system therefore envisages that the spring 40 that acts between seat and valve body ensures sealing for low pressure values, while as the pressure increases it is the fluid itself that exerts an action of pressure of the seat against the ball, which provides the sealing of the valve.

As shown in the drawings, the sealing of the seat on the ball is effected by a sealing element made of elastomeric material positioned in a seating suitably provided on the face of seat 20 that is opposite the ball 30, said sealing element coming into contact with said ball 30.

Said sealing element made of elastomeric material consists of a ring 2b of triangular cross-section, similar to the Greek capital letter delta, that's why is called a “delta-ring”.

This sealing system is characterized in that it comprises a second element made of thermoplastic material 3b, which is also positioned between said seat 20 and said ball 30. In particular, said thermoplastic element is in the shape of a ring preferably of trapezoidal section and is held in a second seating suitably provided, again on the face of said seat that is opposite the ball 30.

Said ring made of thermoplastic material, indicated with 3b in the drawing, can advantageously be positioned corresponding to the lubrication holes 21 provided in seat 20.

According to a second configuration of the system, shown in FIG. 2, said ring made of thermoplastic material 3b can advantageously be positioned close to said sealing ring made of elastomeric material 2b. In this configuration of the system, in which the thermoplastic element is positioned close to the elastomeric sealing ring, the pressure thrust band on the seat, given by the difference between the sealing diameter Y and the thrust diameter X, has a different dimension compared with that of a system in which sealing is achieved exclusively by the elastomeric ring 2b, as it is suitably dimensioned so that the thermoplastic ring 3b, once it is acted upon by the thrust increase under pressure and has come into contact with the ball 30, can also develop a sealing action on the ball, without thereby causing an increase in torque.

Attainment of this situation will mean that the metallic seat follows the deformations of the ball, preserving the stability of the “delta-ring” 2b within its seating, no longer compelled to become destabilized to guarantee sealing.

Still referring to FIGS. 1 and 2, it can be seen that said “delta-ring” elastomeric sealing element 2b is held in position by a retaining element 50, which is inserted in a seating suitably provided in said seat 20 and projects from said seat and faces said ball 30, remaining with at least a part of one of its sides in contact with the elastomeric sealing element 2b.

The function of said retaining element 50 is to hold the elastomeric sealing element 2b in its seating, which requires, for performing its function, a seating that is sufficiently open towards said ball 30 to permit deformation of element 2b.

Valve sealing, particularly at high working pressures, is in fact ensured by the possibility that the seat can deform to follow the deformation of the ball valve. In fact, with the valve closed, the fluid, moving along the direction of axis A, flows round the ball 30 and, at high pressures, the ball deforms under the action of the thrust of the fluid.

When the ball deforms, seat 20 is unable to follow the deformation of the ball, and sealing is provided substantially by the capacity of the sealing element 2b to deform as well, compensating the deformation of the ball.

More particularly, the “delta-ring” sealing element 2b is deformed by the fluid pressure P that acts tangentially on said element, tending to extrude it from its seating.

The problem of securing the sealing element 2b in its seating is further accentuated during valve opening/closing operations, with the valve under pressure.

The problem just illustrated, namely the need to ensure that the elastomeric sealing element 2b deforms to provide sealing, is accentuated on valves of large diameter and as the pressures increase. It should be recalled that the ball 30 swivels on a vertical rotation axis. This translates into accentuated deformation of the ball corresponding to points farthest from the rotation axis, and almost zero deformation corresponding to points close to the rotation axis. For valves of moderate diameter, in which the distance of the points of the ball from the vertical rotation axis is small, the fluid pressures are very high, whereas for valves with larger diameters, for which the fluid pressures are generally not so high, there are points of the ball that are more distant from said rotation axis, and are therefore more liable to deform.

Referring to FIG. 3, seat 20 also deforms under the action of the pressure, which presses it against the valve, however this too will be maintained substantially in the initial position, undeformed from bearing on the ball corresponding to the central points C and C′ substantially in line with the rotation axis of the ball, while it will tend to deform at points D and D′ that are farther from the axis.

As already said, the solution of the type known from the prior art envisages that the sealing element 2b is always held in its seating by the presence of the retaining element 50.

This retaining element 50, generally made of a metallic material, is inserted in a suitable seating provided directly on seat 20, adjacent to the seating of said sealing element 2b.

As can be seen from FIG. 2, in particular, the presence of the retaining element 50, while on the one hand making it easier to insert said sealing element 2b in its seating, as the latter has a quite wide opening, on the other hand leads to weakening of the seat itself, as it becomes necessary to provide an additional seating for the retaining element 50 and this seating, being adjacent to the seating of said sealing element 2b, reduces the rigidity of seat 20.

Accordingly, the solution of the type known from the prior art, shown in FIGS. 1 and 2, has the drawback that the seat is not as strong, as it is of reduced section, because of the need to provide an additional seating for insertion of the retaining element 50.

Moreover, another drawback affecting this sealing system of the known type consists of reduced rigidity of the entire seat, bearing in mind the clearances that are in any case present between said retaining element 50 and seat 20, and between the retaining element 50 and the elastomeric sealing element 2b. Yet another drawback of the system described so far, known from the prior art, is the difficulty of machining the seatings, both the seating of the sealing element 2b and the seating of the retaining element 50, owing to the very small tolerances and the limited mating clearances.

### SUMMARY OF THE INVENTION

The problem to be solved by the present invention is to provide an improved sealing system for two-way industrial safety valves that that can overcome the drawbacks that affect the systems of the type known from the prior art.

Within said problem, one of the aims of the present invention is to provide a sealing system for two-way industrial valves that enables the mechanical characteristics of the seat to be optimized.

In particular, one aim of the present invention is to provide a sealing system that makes it possible to increase, relative to the systems of the known type, the rigidity of the system, in particular of the seat and of the elastomeric sealing element.

A further aim of the present invention is to provide a sealing system that requires simpler operations for machining the seating of said sealing element and simpler operations for assembly of said sealing element in its seating.

Yet another aim of the present invention is to provide an improved sealing system that makes it possible, at equal diameter of the valve, to reach higher fluid pressures, or, at equal pressures, to be able to produce valves of larger diameter.

### BRIEF DESCRIPTION OF THE DRAWINGS

Further characteristics and advantages of the present invention will become clearer from the following detailed description, given as a non-limiting example and illustrated in the appended drawings, in which:

FIG. 1 shows a sealing system for industrial double-acting piston valves of the type known from the prior art;

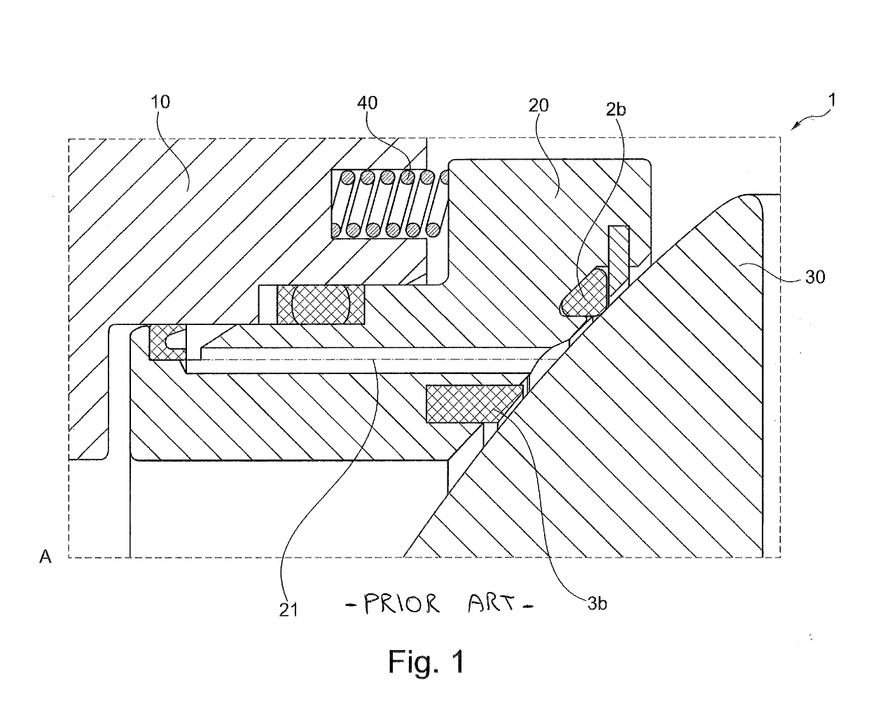

FIG. 2 shows a variant of the sealing system of the known type shown in FIG. 1;

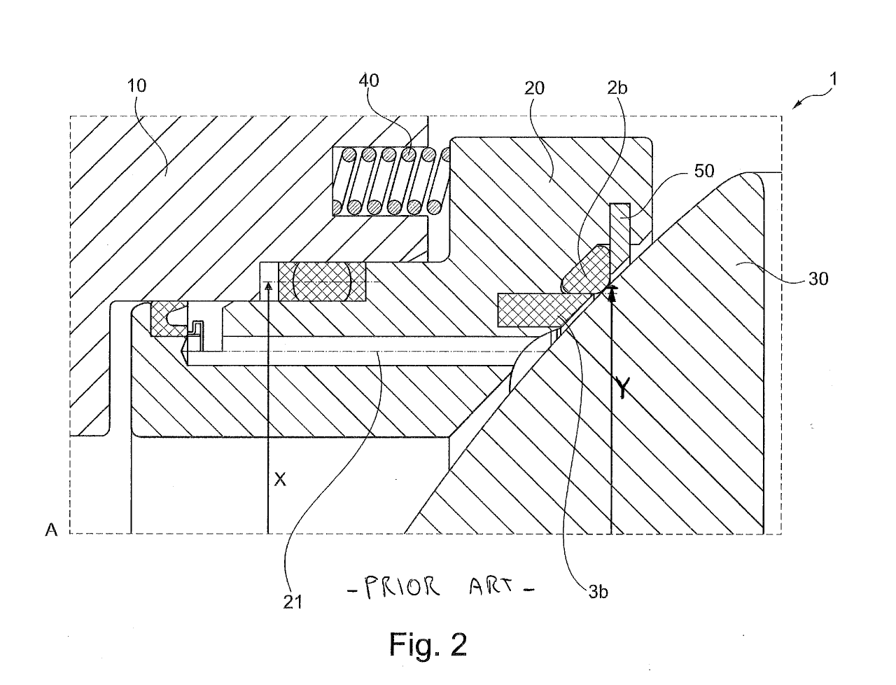

FIG. 3 shows a front view of a seat according to the sealing system according to the present invention;

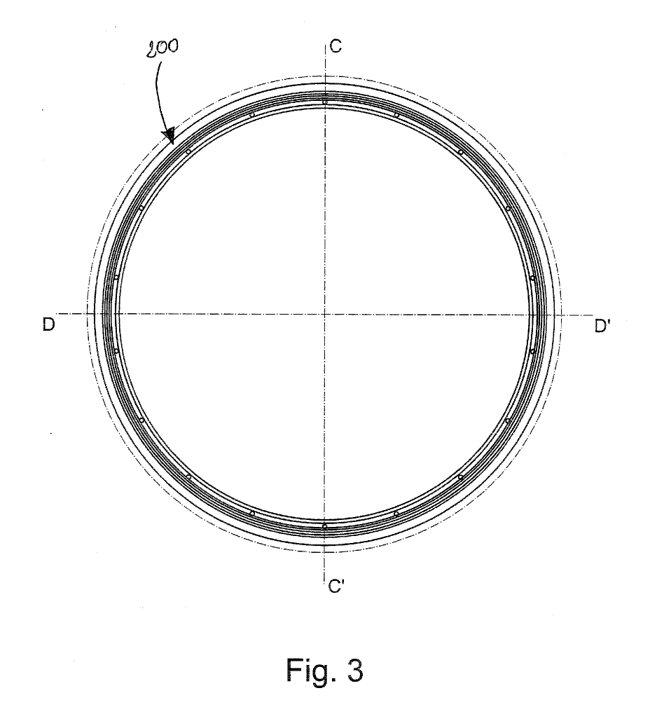

FIG. 4 shows a section through the seat of FIG. 3 according to the present invention, indicating the dual sealing function of elements 500 and 600 in contact with ball 300;

FIG. 5 shows a longitudinal section of the safety valve comprising two seats according to the present invention.

### DETAILED DESCRIPTION OF THE INVENTION

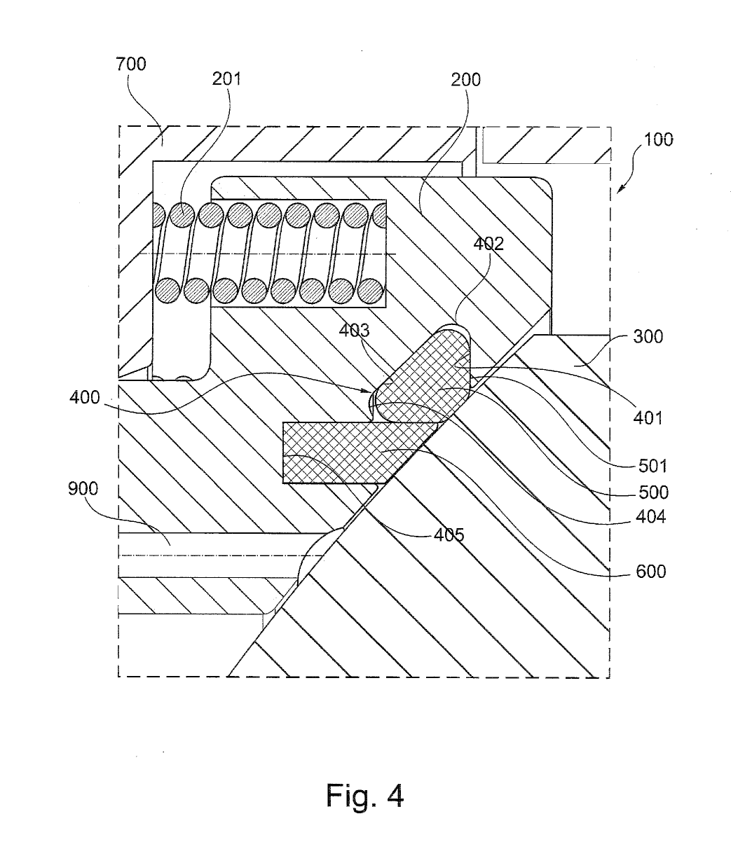

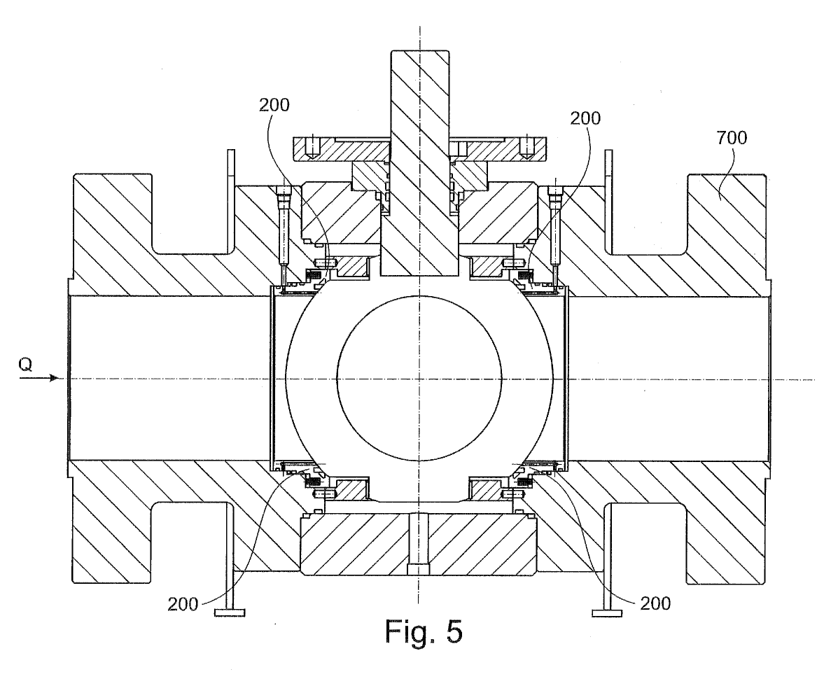

Referring in particular to FIG. 4, the sealing system 100 according to the present invention comprises a seat 200 for sealing on a ball 300 and able to interact with a valve body 700, seen more clearly in FIG. 5.

The seat 200 interacts with the valve body in the manner known from the prior art, therefore, for example, a helical spring 201 and an O-ring seal, a “U” collar 60 and two “BK” collars 70 can advantageously be provided between said seat 200 and said valve body.

The operation of two-way, single-action or double-action piston safety valves, of the type to which the sealing system according to the present invention applies, is known.

The pressure exerted by the fluid that acts on the external part of seat 200 pushes said seat against ball 300, while the pressure that acts on the internal part of the seat moves it away from ball 300.

The sealing system according to the present invention comprises a sealing element made of elastomeric material 500 positioned in a seat 400 and of a sealing element made of thermoplastic material 600 positioned in a seat 405, suitably provided on the face of seat 200 that is opposite ball 300, said sealing elements coming into contact with said ball 30 when the sealing system is assembled in a valve.

Said sealing element made of elastomeric material 500 consists of a ring of triangular cross-section, similar to the Greek capital letter delta, and therefore called a “delta-ring”.

This sealing system is characterized in that it comprises a second element made of thermoplastic material 600, also positioned between said seat 200 and said ball 300. In particular, said thermoplastic element has the shape of a ring preferably of trapezoidal section and is housed in a second seat 600a, again suitably provided on the face of said seat that is opposite ball 300.

Said ring made of thermoplastic material, indicated in the drawing with 600, is advantageously positioned close to the elastomeric element 500 for the purpose of retaining it in the seating and of becoming a second sealing element as the pressure rises.

The sealing system according to the present invention is thus more compact than the system provided with a retaining element 50 known from the prior art, and the compactness of the seat translates into a reduction of the final costs of the seat and of the whole valve in which the seat is assembled.

In this way there is the further result that it allows the technician to install the seat according to the present invention even in situations in which the designer cannot alter the existing design for reasons of costs and overall dimensions.

The new seat design is able to increase the performance of seals of seats, and makes it possible to optimize the function of rubber gaskets even in extreme operating conditions.

In fact, it has been stated that the problem of valve sealing is associated with the deformations of the ball and seat in operation.

Now, with the new sealing system it is possible to make a seat, as mentioned, of optimized resisting section compared with the seats of the known type, and the particular configuration means that said seat can follow the deformations of the ball, safeguarding the elastomeric element 2b even in conditions of high pressure.

It should also be pointed out that this type of solution with double sealing, in which at high pressures sealing is provided both by the elastomeric element 500 and by the thermoplastic element 600, also makes it possible to obtain sealing called “PRIMARY METAL-SECONDARY SOFT”, by suitable dimensioning and machining of the projections of the rubber and thermoplastic inserts relative to the seat 200, which allow the elastomeric element 500 to go back into its seating sufficiently. Moreover, it permits application to so-called “FIRE SAFE” seals, by suitable machining of the metallic seat “downstream” of the sealing gaskets.

As shown in the appended drawings, in particular in FIG. 4, seat 200 according to the present invention has a seating 400 suitably arranged for receiving said elastomeric element 500 and said thermoplastic element 600.

Seating 400 is thus configured in order to have its opening facing ball 300, when the seat is mounted in a valve. Overall, therefore, seat 400 allows the elastomeric sealing element 500 and the thermoplastic element 600 to project from the seat in order to come into contact with ball 300, when the seat is installed.

In even more detail, seating 400 of sealing element 500 will have an internal profile comprising at least one first seating 405 suitable for receiving said thermoplastic element 600, having a cross-section, as can be seen in FIG. 4, that is substantially rectangular with a horizontal longitudinal extension and open at the front, which is joined by a first rounded section 404 to a bottom edge 403 that is substantially flat and is inclined in a direction substantially tangential to the section of external surface of ball 300 towards which said seat 400 faces.

The bottom edge 403 is then joined via a second rounded section 402 to a final section 401, the direction of which forms an acute angle with the direction of said bottom edge 403, said final section 401 thus defining a substantially vertical direction, where the horizontal and vertical directions are those that can be derived from the orientation shown in FIGS. 4 and 5: the horizontal direction substantially coincides with the direction of the flow Q, indicated in FIG. 5, that passes through the valve, while the vertical direction is the direction orthogonal thereto.

Clearly, FIG. 4 shows the orientation of the seat and of the components of the sealing system in one assembled valve configuration.

Therefore, as described thus far, the thermoplastic element 600 and the elastomeric sealing element 500 are assembled on the seat by fitting them in seating 400 according to dimensional tolerances that allow stable and functional assembly thereof.

In particular, the functionality of the elastomeric sealing element 500 envisages, as already mentioned, that the same element is able to deform elastically when, under the effect of the pressures, seat 200 is pushed against ball 300, and said elastomeric element is called upon to effect sealing on the ball. For this reason the assembly of the elastomeric element 500 in seating 400 envisages that it comes into contact with the bottom edge 403 of said seating, while there is a clearance between said sealing element 500 and the rounded sections 402 and 404 with the element assembled.

This clearance permits deformation of the sealing element 500 in operation. Moreover, the final section 401 and the lateral surface of the thermoplastic element 600 that is in contact with said sealing element 500, constrain the latter to project towards the ball 300 over a predetermined section, which permits sealing and deformability of the elastomeric element 500 but, at the same time, prevents this being able to come out of its seating when stressed during operation of the valve.

It has thus been shown that the sealing system for industrial valves according to the present invention achieves the proposed purpose and objects.

In particular, it has been illustrated how the system according to the present invention makes it possible to obtain optimum sealing even at very high working pressures.

The particular conformation of the seating for the respective sealing and thermoplastic elements provided by the seat according to the present invention differs from every other type of seat in compactness and better protection of sealing, owing to the greater efficiency of the part made of rubber, safeguarded by the thermoplastic insert, and the effective barrier to high pressures of the second seal, again made possible by this second thermoplastic element.

The overall process of manufacture of the seats of valves with a single-acting or double-acting piston of the type considered here was investigated in detail and industrialized so as to obtain constant performance while varying the dimensions of the seats. In fact, the section profiles were varied dimensionally for the various ranges of nominal diameter, from 1.½″ up to 56″ with different profiles with respect to volumes of rubber and dimensions of the elastomeric and thermoplastic elements, always complying with the structure described here. In addition, combinations of materials in rubber and engineering polymer were investigated and tested appropriately, as well as the processes for machining, assembly and finishing for qualitatively guaranteeing the final product.

The sealing system according to the present invention has the further advantage of smaller overall manufacturing dimensions, with consequent reduction of the final costs of the seat and of the whole valve.

All these features make it possible to obtain a product of high technical content, able to cover a very wide range of applications.

Numerous modifications can be made by a person skilled in the art without departing from the scope of protection of the present invention.

Accordingly, the scope of protection of the claims is not to be limited by the illustrations or by the preferred embodiments shown as examples in the description, but rather the claims must comprise all the characteristics of patentable novelty deducible from the present invention, including all characteristics that would be treated as equivalent by a person skilled in the art.

1. A sealing system for industrial valves, comprising at least one seat suitable for insertion in the housing of a ball valve, a seating suitably arranged on said seat corresponding to the surface of said seat intended to be opposite said ball, a sealing element made of elastomeric material housed within said seating and able to provide fluid sealing between said seat and said ball of said valve, a further element made of thermoplastic material also housed in said seating, wherein the perimeter of said sealing element is in contact exclusively with said thermoplastic element and the internal edges of said seating, by which it is held stably in position.

2. The sealing system according to claim 1, characterized wherein said seating comprises a first seating having a substantially rectangular cross-section open at the front suitable for receiving said thermoplastic element, a first rounded section that connects said first seating to a substantially flat bottom edge, a second rounded section that connects said bottom edge to a final section, the direction of which forms an acute angle with the direction of said bottom edge.

3. The sealing system according to claim 2, wherein said element made of thermoplastic material is a ring with a polygonal cross-section.

4. The sealing system according to claim 3, wherein said ring has a trapezoidal cross-section.

5. The sealing system according to claim 3, wherein with the system assembled, said sealing element is in contact with said bottom edge and said final section, a clearance being provided between said seating and said sealing element corresponding to said first and second rounded section of said seating.

6. The sealing system according to claim 1, wherein said element made of thermoplastic material is preferably made of polymer material.

7. The sealing system according to claim 1, wherein said sealing element made of elastomeric material consists of an O-ring of circular cross-section.

8. A ball valve comprising the sealing system according to claim 1.

9. The ball valve according to claim 8 wherein the ball valve is a double-acting piston ball valve.

10. The sealing system according to claim 4, wherein with the system assembled, said sealing element is in contact with said bottom edge and said final section, a clearance being provided between said seating and said sealing element corresponding to said first and second rounded section of said seating.
